(19) United States
(12) Patent Application Publication
(10) Pub. No.: US 2025/0267298 A1
(43) Pub. Date: Aug. 21, 2025

(54) DOWN-SAMPLING METHODS AND RATIOS FOR SUPER-RESOLUTION BASED VIDEO CODING

(71) Applicants: DOUYIN VISION CO., LTD., Beijing (CN); BYTEDANCE INC., Los Angeles, CA (US)

(72) Inventors: Chaoyi Lin, Beijing (CN); Yue Li, San Diego, CA (US); Kai Zhang, San Diego, CA (US); Zhaobin Zhang, San Diego, CA (US); Li Zhang, San Diego, CA (US)

(21) Appl. No.: 19/178,167

(22) Filed: Apr. 14, 2025

Related U.S. Application Data
(63) Continuation of application No. PCT/CN2023/124739, filed on Oct. 16, 2023.

(30) Foreign Application Priority Data
Oct. 14, 2022 (WO) PCT/CN2022/125383

(51) Int. Cl. H04N 19/33; H04N 19/117; H04N 19/176; H04N 19/80

(52) U.S. Cl. CPC H04N 19/33; H04N 19/117; H04N 19/176; H04N 19/80

(57) ABSTRACT

A mechanism for processing video data is disclosed. The mechanism includes determining to apply neural network (NN) based super resolution. A chroma format of an input is changed due to different down-sampling ratios of color components. A conversion is performed between a visual media data and a bitstream based on the chroma format.

### CROSS-REFERENCE TO RELATED APPLICATIONS

This is a continuation of International Patent Application No. PCT/CN2023/124739, filed on Oct. 16, 2023, which claims the priority to and benefits of International Patent Application No. PCT/CN2022/125383, filed on Oct. 14, 2022. All the aforementioned patent applications are hereby incorporated by reference in their entireties.

### TECHNICAL FIELD

The present disclosure relates to generation, storage, and consumption of digital audio video media information in a file format.

### BACKGROUND

Digital video accounts for the largest bandwidth used on the Internet and other digital communication networks. As the number of connected user devices capable of receiving and displaying video increases, the bandwidth demand for digital video usage is likely to continue to grow.

### SUMMARY

A first aspect relates to a method for processing video data comprising: determining to apply neural network (NN) based super resolution (SR), wherein a chroma format of an input is changed due to different down-sampling ratios of color components; and performing a conversion between a visual media data and a bitstream based on the chroma format.

A second aspect relates to an apparatus for processing video data comprising: a processor; and a non-transitory memory with instructions thereon, wherein the instructions upon execution by the processor, cause the processor to perform any of the preceding aspects.

A third aspect relates to a non-transitory computer readable medium comprising a computer program product for use by a video coding device, the computer program product comprising computer executable instructions stored on the non-transitory computer readable medium such that when executed by a processor cause the video coding device to perform the method of any of the preceding aspects.

A fourth aspect relates to a non-transitory computer-readable recording medium storing a bitstream of a video which is generated by a method performed by a video processing apparatus, wherein the method comprises: determining to apply neural network (NN) based super resolution, wherein a chroma format of an input is changed due to different down-sampling ratios of color components; and generating the bitstream based on the determining.

A fifth aspect relates to a method for storing bitstream of a video comprising: determining to apply neural network (NN) based super resolution, wherein a chroma format of an input is changed due to different down-sampling ratios of color components; generating the bitstream based on the determining; and storing the bitstream in a non-transitory computer-readable recording medium.

A sixth aspect relates to a method, apparatus or system described in the present document.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram illustrating an example of reference picture resampling (RPR).

FIG. 2 is a schematic diagram illustrating an example of de-convolution.

FIG. 3 is a schematic diagram illustrating an example of pixel shuffle based up-sampling.

FIG. 4 is a schematic diagram illustrating an example SR network, where RB denotes residual blocks, and R and M denote a number of feature maps after convolution.

FIG. 5 is a schematic diagram illustrating an example of obtaining residual blocks, where M denotes a number of filters.

FIG. 6 is a schematic diagram of an example of an inverse pixel shuffle process.

FIGS. 7A-7D are schematic diagrams illustrating examples of different positions for upsampling.

FIG. 8 is a schematic diagram illustrating an example downsampling network.

FIG. 9 is a schematic diagram of an example model for luma up-sampling.

FIG. 10 is a block diagram showing an example video processing system.

FIG. 11 is a block diagram of an example video processing apparatus.

FIG. 12 is a flowchart for an example method of video processing.

FIG. 13 is a block diagram that illustrates an example video coding system.

FIG. 14 is a block diagram that illustrates an example encoder.

FIG. 15 is a block diagram that illustrates an example decoder.

FIG. 16 is a schematic diagram of an example encoder.

### DETAILED DESCRIPTION

It should be understood at the outset that although an illustrative implementation of one or more embodiments are provided below, the disclosed systems and/or methods may be implemented using any number of techniques, whether currently known or yet to be developed. The disclosure should in no way be limited to the illustrative implementations, drawings, and techniques illustrated below, including the exemplary designs and implementations illustrated and described herein, but may be modified within the scope of the appended claims along with their full scope of equivalents.

Section headings are used in the present document for ease of understanding and do not limit the applicability of techniques and embodiments disclosed in each section only to that section. Furthermore, the techniques described herein are applicable to other video codec protocols and designs.

### 1. Initial Discussion

This document is related to video coding technologies. Specifically, it is related to the super resolution based up-sampling technologies in video coding. It may be applied to the existing video coding standards like High Efficiency Video Coding (HEVC), or Versatile Video Coding (VVC). It may also be applicable to other video coding standards or video codecs, or being used as a post-processing method which is out of encoding/decoding process.

### 2. Abbreviations

The present disclosure includes the following abbreviations: adaptive loop filter (ALF), deblocking filter (DBF), discrete cosine transform (DCT)-based interpolation filter (DCTIF), high-resolution (HR), International Organization for Standardization (ISO), International Electrotechnical Commission (IEC), low-resolution (LR), reference picture resampling (RRP), sample adaptive offset (SAO), VVC test model (VTM), and versatile video coding (VVC).

### 3. Video Coding Standards

Video coding standards have evolved primarily through the development of the well-known International Telecommunication Union-Telecommunication Standardization Sector (ITU-T) and ISO/IEC standards. The ITU-T produced H.261 and H.263, ISO/IEC produced Moving Picture Experts Group (MPEG)-1 and MPEG-4 Visual, and the two organizations jointly developed the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, Joint Video Exploration Team (JVET) was founded by Video Coding Experts Group (VCEG) and MPEG jointly. Many additional methods have been adopted by JVET and put into the reference software named Joint Exploration Model (JEM). The Joint Video Expert Team (JVET) between VCEG (Q6/16) and ISO/IEC JTC1 SC29/WG11 (MPEG) was created to work on the VVC standard. VVC version 1 achieved an approximate 50% bitrate reduction compared to HEVC.

An example VVC draft, i.e., Versatile Video Coding (Draft 10) could be found at: http://phenix.it-sudparis.eu/jvet/doc_end_user/current_document.php?id=10399. An example reference software of VVC, named VTM, could be found at: https://vcgit.hhi.fraunhofer.de/jvet/VVCSoftware_VTM/-/tags.

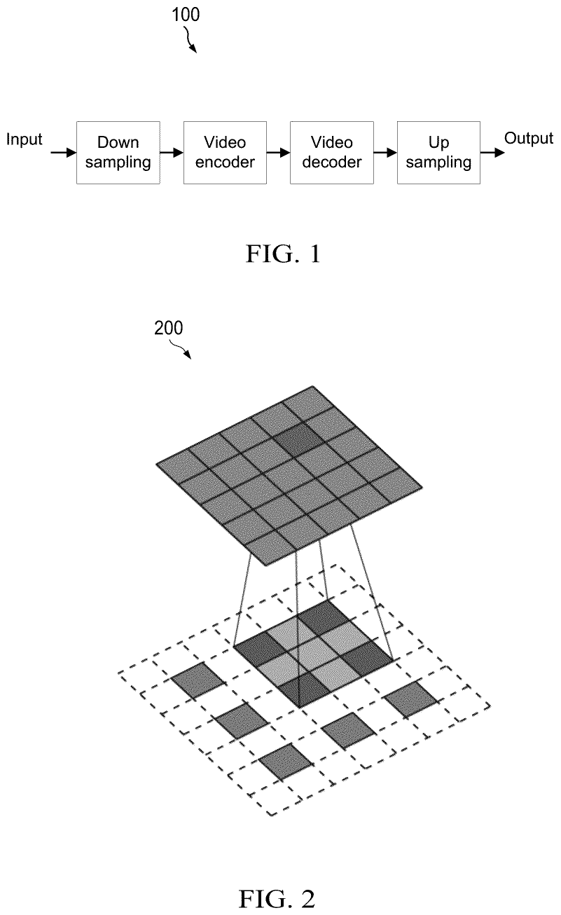

FIG. 1 illustrates an example of reference picture resampling (RPR) 100. The reference picture resampling (RPR) is a mechanism in VVC where pictures in the reference lists can be stored at a different resolution from the current picture and then resampled in order to perform regular decoding operations. The inclusion of this technique supports interesting application scenarios such as real-time communication with adaptive resolution, adaptive streaming with open group of pictures (GOP) structures. As shown in FIG. 1, a down-sampled (a.k.a., downsampled or down sampled) sequence is encoded and then the reconstruction is up-sampled (a.k.a., upsampled, or up sampled) after decoding.

### 3.1 Up-Sampling Technology

Commonly used or traditional up-sampling technology is discussed. In VTM 11.0, the up-sampling filter is a discreet cosine transform (DCT)-Based Interpolation Filter (DCTIF). Besides that, bi-cubic interpolation and bi-linear interpolation are also commonly used. In these technologies, the weight coefficients for the interpolation filter are fixed once the number of taps of filters is given. Thus, the weight coefficients of these methods may not be optimal.

Learning-based technology is discussed. FIG. 2 illustrates an example of de-convolution 200. De-convolution and pixel shuffle layer are two example solutions in deep learning-based up-sampling technologies. De-convolution, which is also called transposed convolution, is usually used for up-sampling in deep learning. In this method, the stride for convolution is the same as the scaling ratio. The bottom matrix is the low-resolution input where white blocks are the padded value with zeros and the gray block denotes the original samples in low-resolution. The top matrix is the high-resolution output. In this example, the stride=2.

FIG. 3 illustrates an example of pixel shuffle based up-sampling 300. The pixel shuffle layer is another method for up-sampling used in deep learning. As shown in FIG. 3, the pixel shuffle is usually placed after a convolution layer. The number of filters of this convolution is M=Cₒᵤₜr², where Cₒᵤₜ is the number of output channels and r denotes the up-scaling ratio. For example, given a low-resolution input with the size of H×W×3, if the size of high-resolution output is 2H×2W×3, then the number of filters M=3×2²=12. The pixel shuffle technique is described in further detail with regard to FIG. 6, below.

### 3.2 Convolutional Neural Network-Based Super Resolution For Video Coding

### 3.2.1 Convolutional Neural Networks

Super-resolution (SR) is the process of recovering high-resolution (HR) images from low-resolution (LR) images. SR may also be referred to as up-sampling. In deep learning, a convolutional neural network (a.k.a., CNN, or ConvNet) is a class of deep neural networks, which is applied to analyzing visual imagery. CNNs have very successful applications in image and video recognition/processing, recommender systems, image classification, medical image analysis, natural language processing.

CNNs are regularized versions of multilayer perceptrons. Multilayer perceptrons usually refer to fully connected networks, that is, each neuron in one layer is connected to all neurons in the next layer. The “fully-connectedness” of these networks makes them prone to overfitting data. Regularization is used to alleviate overfitting, e.g., adding some form of magnitude measurement of weights to the loss function. CNNs take a different approach towards regularization. That is, CNNs take advantage of the hierarchical pattern in data and assemble more complex patterns using smaller and simpler patterns. Therefore, on the scale of connectedness and complexity, CNNs are on the lower extreme.

CNNs use relatively little pre-processing compared to other image classification/processing algorithms. This means that the network learns the filters that in traditional algorithms were hand-engineered. This independence from prior knowledge and human effort in feature design is a major advantage.

### 3.2.2 Deep Learning For Image/Video Coding

Deep learning-based image/video compression has two implications: end-to-end compression purely based on neural networks (NNs) and frameworks enhanced by neural networks. The first type takes an auto-encoder like structure, either achieved by convolutional neural networks or recurrent neural networks. While purely relying on neural networks for image/video compression can avoid any manual optimizations or hand-crafted designs, compression efficiency may be not satisfactory. Therefore, works distributed in the second type take neural networks as an auxiliary, and enhance compression frameworks by replacing or enhancing some modules. In this way, they can inherit the merits of the highly optimized frameworks.

### 3.2.3 Convolutional Neural Network Based Super Resolution

In lossy image/video compression, the reconstructed frame is an approximation of the original frame, since the quantization process is not invertible and thus incurs distortion to the reconstructed frame. In the context of RPR of VVC, the input image/video may be down-sampled. Thus, the resolution of original frame is 2× of that of reconstruction. To up-sample the low-resolution reconstruction, a convolutional neural network could be trained to learn the mapping from the distorted low-resolution frame to the original high-resolution frame. In practice, training must be performed prior to deploying the NN-based in-loop filtering. A CNN-based block up-sampling method has been proposed for HEVC. For each coding tree unit (CTU) block, the method determines whether to use down/up- sampling based method or the full-resolution based coding.

### 3.2.3.1 Training

The purpose of the training processing is to find the optimal value of parameters including weights and bias. First, a codec (e.g., the HEVC test model (HM), Joint Exploration Model (JEM), VTM, etc.) is used to compress the training dataset to generate the distorted reconstruction frames. Then the reconstructed frames (low-resolution and compressed) are fed into the NN and the cost is calculated using the output of NN and the ground-truth frames (a.k.a., original frames). Commonly used cost functions include Sum of Absolution Difference (SAD) and Mean Square Error (MSE). Next, the gradient of the cost with respect to each parameter is derived through the back propagation algorithm. With the gradients, the values of the parameters can be updated. The above process repeats until the convergence criteria is met. After completing the training, the derived optimal parameters are saved for use in the inference stage.

### 3.2.3.2 Convolution Process

During convolution, the filter is moving across the image from left to right, top to bottom, with a one-pixel column change on the horizontal movements, then a one-pixel row change on the vertical movements. The amount of movement between applications of the filter to the input image is referred to as the stride, and it is almost always symmetrical in height and width dimensions. The default stride or strides in two dimensions is (1,1) for the height and the width movement.

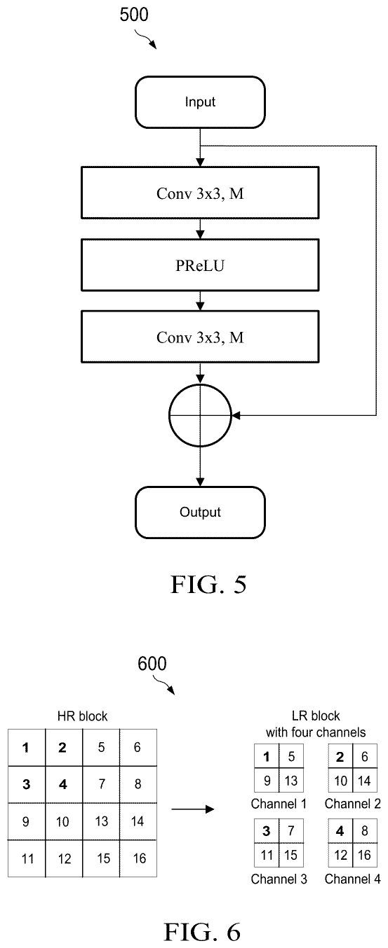

In most of deep convolutional neural networks, residual blocks are utilized as the basic module and stacked several times to construct the final network. FIG. 5 is a schematic diagram illustrating an example of obtaining residual blocks 500, where M denotes the number of filters. As shown in the example of FIG. 5, the residual block is obtained by combining a convolutional layer, a rectified linear unit (ReLU)/parametric rectified linear unit (PReLU) activation function, and a convolutional layer as shown in FIG. 5.

### 3.2.3.3 Inference

During the inference stage, the distorted reconstruction frames are fed into NN and processed by the NN model whose parameters are already determined in the training stage. The input samples to the NN can be reconstructed samples before or after deblocking (DB), or reconstructed samples before or after sample adaptive offset (SAO), or reconstructed samples before or after adaptive loop filter (ALF).

4. Technical problems solved by disclosed embodiments

However, existing designs for NN-based super resolution for video coding have various problems or drawbacks.

First, all the frames in the sequence are down-sampled. However, some frames may prefer the full-resolution encoding. It is desirable to design a mechanism which decides whether to perform down-sampling or up-sampling for each frame. This might be helpful in the random access or low delay configurations.

Second, most down-sampling ratio for input is fixed, such as 2× down-sampling. It might be beneficial to provide different down-sampling ratios for different video units (for example, video unit may be frames or CTUs).

Third, the down-sampling method for the input original sequence is usually the traditional down-sampling method, such as bi-linear interpolation. The neural network based down-sampling can provide higher BD-rate saving.

Fourth, chroma coding performance may be dropped if the chroma components are down-sampled before encoding. By applying different down-sampling ratios for luma and chroma components, only luma components are down-sampled may solve this problem.

5. A listing of solutions and embodiments

To address some or all of the above problems, as well as other problems, methods as summarized below are disclosed. The detailed embodiments should be considered as examples to explain the general concepts and should not be interpreted in a narrow way. In addition, these embodiments can be applied individually or combined in any manner. Furthermore, the presented examples in this document may be applied together with examples in other documents.

In the present disclosure, an NN-based SR can be any kind of NN-based method, such as a convolutional neural network (CNN) based SR. In the following discussion, a NN-based SR may also be referred to as a non-CNN-based method, e.g., using machine learning based solutions.

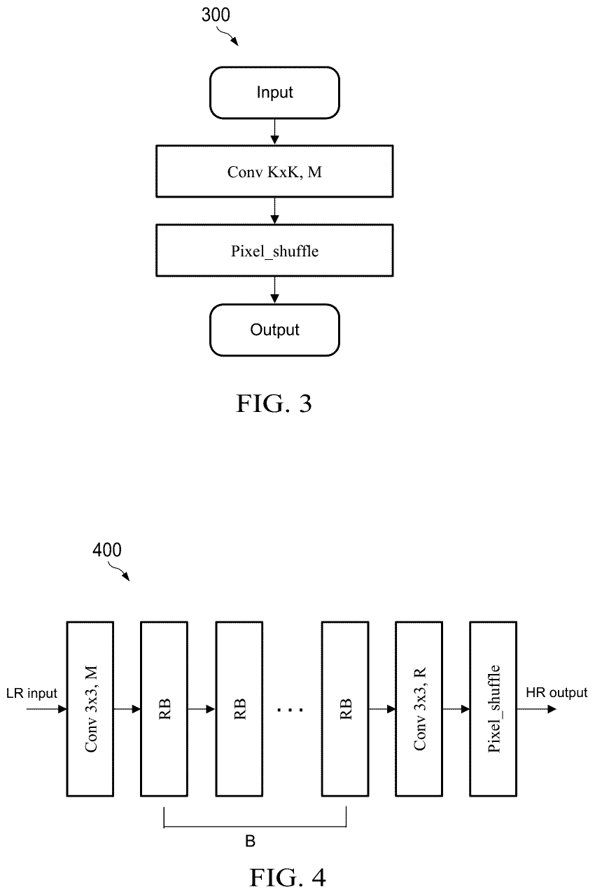

FIG. 4 is a schematic diagram illustrating an example SR network 400.

FIG. 5 is a schematic diagram illustrating an example of residual blocks 500.

FIG. 6 is an example of an inverse pixel shuffle process 600.

In the following discussion, a video unit (a.k.a., video data unit) may be a sequence of pictures, a picture,

a slice, a tile, a brick, a subpicture, a CTU/coding tree block (CTB), a CTU/CTB row, one or multiple coding units (CUs)/coding blocks (CBs), one or multiple CTUs/CTBs, one or multiple Virtual Pipeline Data Unit (VPDU), or a sub-region within a picture/slice/tile/brick. In some embodiments, the video unit may be referred to as a video data unit.

### Example 1

In one example, the down-sampling method may employ designed filters.

In one example, the Discrete Cosine Transform Interpolation Filter (DCTIF) can be used for down-sampling.

In one example, the bilinear interpolation can be used for down-sampling.

In one example, the bicubic interpolation can be used for down-sampling.

In one example, the down-sampling method may be signaled from the encoder to the decoder. In one example, an index may be signaled to indicate the down-sampling filter. In one example, at least one coefficient of the down-sampling filter may be signaled, directly or indirectly. The down-sampling method may be signaled in sequence header/sequence parameter set (SPS)/picture parameter set (PPS)/Picture header/Slice header/CTU/CTB, or any rectangular region. Different down-sampling methods may be signaled for different color components.

In one example, the down-sampling method may be required by the decoder side and informed to the encoder side in an inter-active application.

### Example 2

In one example, the down-sampling method can be neural network (NN) based such as convolutional neural network (CNN) based, method.

The CNN-based down-sampling method should include at least one down-sampling layer. In one example, the convolution with stride of K (e.g., K=2) can be used as the down-sampling layer and the down-sampling ratio is K. In one example, the pixel-unshuffling method followed by a convolution with stride of 1 can be used for down-sampling. The pixel-unshuffling is illustrated in FIG. 6.

### Example 3

A series of down-sampling can be used for achieving a specific down-sampling ratio. In one example, two convolution layers with stride of K (e.g., K32 2) is used in one network. In this condition, the down-sampling ratio is 4. In one example, two traditional down-sampling filters (e.g., a down-sampling ratio of each is 2) are used for a down-sampling ratio of 4.

### Example 4

In one example, the traditional filters and the CNN-based methods can be combined for a specific down- sampling ratio. In one example, the traditional filters is used followed by a CNN-based method. The traditional filter achieves 2× down-sampling and the CNN-based method achieves 2× down-sampling. Thus, the input is down-sampled by 4×.

### Example 5

When down-sampling a specific input video unit level, different down-sampling methods may be compared with each other to choose a best or preferred down-sampling method.

In one example, there are K (e.g., K=3) CNN-based down-sampling models. For one specific input, the three down-sampling models will down-sample the input, respectively. The down-sampled reconstruction will be up-sampled to the original resolution. The quality metric (e.g., peak signal-to-noise ratio (PSNR)) is utilized to measure the three up-sampled results. the model who achieves the best performance will be utilized to the real down-sampling. In one example, the quality metric is multi-scale structural similarity index measure (MS-SSIM). In one example, the quality metric is PSNR.

The index of the down-sampling methods may be signaled to the encoder or decoder.

### Example 6

The down-sampling methods may be signaled to the decoder.

In one example, the CNN-based down-sampling methods are used for down-sampling. For one specific video unit (e.g., frame) level, the index of chosen model will be signaled to the decoder.

In one example, different CTUs within one frame use different down-sampling methods. In this condition, all the index of the corresponding methods may be signaled to the decoder.

In one example, at least one coefficient of the down-sampling filter may be signaled, directly or indirectly.

Different down-sampling methods may be signaled for different color components.

In one example, the down-sampling method may be required by the decoder side and informed to the encoder side in an inter-active application.

### Example 7

The input of down-sampling methods can be at all the video unit (e.g., sequence/picture/slice/tile/brick/subpicture/CTU/CTU row/one or multiple CUs or CTUs/CTBs) levels.

In one example, the input is the frame level with size of its original resolution.

In one example, the input is one CTU level with size of 128×128.

### Example 8

In one example, the input is a block within one frame whose size is not limited.

In one example, it can be a block with spatial size (M, N), for example, M=256, N=128.

### Example 9

In one example, the down-sampling ratio can be different for all the video unit (e.g., sequence/picture/slice/tile/brick/subpicture/CTU/CTU row/one or multiple CUs or CTUs/CTBs) levels.

In one example, the down-sample ratio is 2 for all the frames of one sequence. In one example, the down-sample ratio is 2 for all the CTUs of one frame.

In one example, the down-sample ratio is 2 for the first frame and it may be 4 for the next frame.

The combination of down-sampling ratios for different video unit levels may be used. In one example, the down-sample ratio is 2 for one frame and it may be 4 for one CTU in the same frame. In the condition, the CTU will be down-sampled by 4×.

### Example 10

In one example, the down-sampling ratio can be different for all the components of the input video unit level.

In one example, the down-sampling ratio is 2 for both luma and chroma components.

In another example, the down-sampling ratio is 2 for luma component and it is 4 for chroma components.

### Example 11

In one example, the down-sampling ratio can be 1 which means no down-sampling is performed.

Such be applied at all the video unit (e.g., a down-sampling ratio can sequence/picture/slice/tile/brick/subpicture/CTU/CTU row/one or multiple CUs or CTUs/CTBs) levels.

### Example 12

The down-sampling ratio can be determined by comparison.

In one example, there are 2× and 4× down-sampling ratios for one frame that can be used. In this condition, the encoder may compress the frame with 2× down-sampling, and then compress the frame with 4× down-sampling. Subsequently, the low-resolution reconstruction may be up-sampled with the same up-sampling method. Then, the quality metric (e.g., PSNR) of each result is calculated, and the down-sampling ratio which achieves the best reconstruction quality will be chosen as the down-sampling ratio for compression. In one example, the quality metric is MS-SSIM.

### Example 13

The determination may be performed at encoder or at decoder.

If the determination is at decoder, the distortion may be calculated based on samples other than the current picture/slice//CTU/CTB, or any rectangular region.

### Example 14

Different quality metrics can be used as metrics for the comparison.

In one example, the quality metric is PSNR.

In one example, the quality metric is SSIM.

In one example, the quality metric is MS-SSIM.

In one example, the quality metric is video multi-method assessment fusion (VMAF).

### Example 15

In one example, the down-sampling ratio may be signaled in the video unit level.

In one example, the CNN information may be signaled in SPS/PPS/Picture header/Slice header/CTU/CTB.

### Example 16

In one example, the chroma format of input will be changed due to the different down-sampling ratios of color components.

In one example, the input chroma format is YUV 4:2:0 and it will be changed to YUV 4:4:4 when the down-sampling ratio is 2 for luma components, and is 1 for chroma components.

### Example 17

In one example, the luma components can be down-sampled at all the video unit (e.g., sequence/picture/slice/tile/brick/subpicture/CTU/CTU row/one or multiple CUs or CTUs/CTBs) levels.

In one example, the down-sampled luma components are from one frame.

In one example, the down-sampled luma components are from one CTU.

### Example 18

In one example, the changed chroma format will be used for compression in the encoder.

In one example, the chroma format is changed from YUV 4:2:0 to YUV 4:4:4 and YUV 4:4:4 will be

used as the chroma format for compression.

In one example, the necessary information to recover the original chroma format is signaled in the video unit level. In one example, the down-sampling ratios for all the color components are signaled in SPS/PPS/Picture header/Slice header/CTU/CTB. In one example, the original chroma format is signaled in SPS/PPS/Picture header/Slice header/CTU/CTB.

### Example 19

In one example, the neural network-based tools can be used in the encoder and decoder.

In one example, to achieve better coding performance, the neural network-based in-loop filter can be used. In one example, two neural network-based in-loop filters are applied to the down-sampled luma reconstruction and chroma reconstruction, respectively. In one example, as one input of neural network-based in-loop filter for chroma, the down-sampled luma reconstruction is concatenated with the chroma reconstruction.

In one example, to recover the original chroma format, the neural network-based super resolution can be applied to the luma components of reconstructed YUV as post filter.

In one example, to recover the original chroma format, the neural network-based super resolution can be applied before in-loop filters.

### Other examples

It is proposed that for two sub-regions within a video unit (e.g., a picture/slice/tile/subpicture), two different SR methods may be applied.

In one example, the SR methods may include the NN-based solution.

In one example, the SR methods may include the non-NN-based solution (e.g., via the traditional filters).

In one example, for a first sub-region, the NN-based solution is used, and for a second sub-region, the non-NN-based solution is used.

In one example, for a first sub-region, the NN-based solution with a first design/model is used, and for a second sub-region, the NN-based solution with a second design/model is used. In one example, the first/second design may have different inputs. In one example, the first/second design may have different number of layers. In one example, the first/second design may have different strides.

In one example, indications of the allowed SR methods and/or which SR method to be used for a sub- region may be signaled in the bitstream or derived on-the-fly. In one example, it may be derived according to decoded information (e.g., how many/ratio of samples are intra coded). In one example, it may be derived according to the SR solution used for a reference sub-region (e.g., co-located sub-region).

A candidate set for a video unit may be pre-defined or signaled in the bitstream wherein the candidate set may include multiple SR solutions for samples in the video unit to be chosen from.

In one example, the candidate set may include multiple NN-based methods with different models/designs.

In one example, the candidate set may include NN-based methods and non-NN-based methods.

In one example, different candidate sets of NN-based SR models are used for different cases, e.g., according to decoded information. In one example, there are different sets of NN-based SR models corresponding to different color components, and/or different slice types, and/or different quantization parameters (QPs). In one example, QP may be categorized into several groups. For example, different NN-based SR models may be used for different groups [QP/M], wherein M is an integer such as 6. In one example, the QP is fed into the SR model where one model can correspond to all the QPs. In this condition, only one QP group is used. In one example, luma component and chroma component may adopt different sets of NN-based SR models. In one example, a first set of NN-based SR models is applied to luma component, and a second set of NN-based SR models is applied to at least one chroma components. In one example, each color components is associated with its own set of NN-based SR models. Alternatively, furthermore, how many sets of NN-based SR models to be applied for the three-color components may depend on the slice/picture types, and/or partitioning tree types (single or dual tree), et. al. In one example, two slice types (e.g., I slice and B (or P) slice) may utilize different sets of NN-based SR models. In one example, for a first color component, two slice types (e.g., I slice and B (or P) slice) may utilize different sets of NN-based SR models; while for a second color component, two slice types (e.g., I slice and B (or P) slice) may utilize same set of NN-based SR models. In one example, for each QP or QP group, one NN-based SR model is trained. The number of NN models is equal to the number of QPs or QP groups.

In one example, the NN-based (e.g., CNN-based) SR and the traditional filters can be used together.

In one example, for different video unit (e.g., sequence/picture/slice/tile/brick/subpicture/CTU/CTU row/one or multiple CUs or CTUs/CTBs) levels, different up-sampling can be used together. For example, for different CTUs in one picture, some CTUs may choose the traditional filters and other CTUs may prefer the NN-based SR methods.

In one example, the selection of NN-based SR and the traditional filters may be signaled from the encoder to the decoder. The selection may be signaled in sequence header/SPS/PPS/Picture header/Slice header/CTU/CTB, or any rectangular region. Different selections may be signaled for different color components.

In above examples, the traditional filters can be used as the up-sampling method.

In one example, the DCT interpolation filter (DCTIF) can be used as the up-sampling method.

In one example, the bilinear interpolation can be used as the up-sampling method.

In one example, the bi-cubic interpolation can be used as the up-sampling method.

In one example, the Lanczos interpolation can be used as the up-sampling method.

In one example, the up-sampling method may be signaled from the encoder to the decoder. In one example, an index may be signaled to indicate the up-sampling filter. In one example, at least one coefficient of the up-sampling filter may be signaled, directly or indirectly. The up-sampling method may be signaled in sequence header/SPS/PPS/Picture header/Slice header/CTU/CTB, or any rectangular region. Different up-sampling methods may be signaled for different color components.

In one example, the up-sampling method may be required by the decoder side and informed to the encoder side in an inter-active application.

In one example, a NN-based SR can be used as the up-sampling method. In one example, the network of the SR should include as least one up-sampling layer. In one example, the neural network may be CNN. In one example, the de-convolution with a stride of K (e.g., K=2) may be used as the up-sampling layer, such as is illustrated in FIG. 2. In one example, the pixel shuffling method may be used as the up-sampling layer, such as is illustrated in FIG. 3.

The NN-based (e.g., CNN-based) SR may be applied to certain slice/picture types, certain temporal layers, or certain slices/picture according to reference picture list information.

Certain selections of up-sampling methods are discussed below.

Whether and/or how to use NN-based (e.g., CNN-based) SR (denoted as CNN information) may depend on video standard profiles or levels.

Whether and/or how to use NN-based (e.g., CNN-based) SR (denoted as CNN information) may depend on color components.

Whether and/or how to use NN-based (e.g., CNN-based) SR (denoted as CNN information) may depend on picture/slice type.

Whether and/or how to use NN-based (e.g., CNN-based) SR (denoted as CNN information) may depend on the contents or coded information of a video unit. In one example, when the variances of the reconstruction samples are greater than a predefined threshold, NN-based SR will be used. In one example, when the energy of the high frequency components of the reconstruction samples is greater than a predefined threshold, NN-based SR will be used.

Whether and/or how to use NN-based (e.g., CNN-based) SR (denoted as CNN information) may be controlled at a video unit (e.g., sequence/picture/slice/tile/brick/subpicture/CTU/CTU row/one or multiple CUs or CTUs/CTBs) level. CNN information may comprise an indication of enabling/disabling the CNN filters, which kind of CNN filter is applied, CNN filtering parameters, CNN models, stride for a convolutional layer, and/or precision of CNN parameters.

In one example, CNN information may be signaled in the video unit level. In one example, the CNN information may be signaled in sequence header/SPS/PPS/Picture header/Slice header/CTU/CTB, or any rectangular region.

The number of different CNN SR models and/or sets of CNN set models may be signaled to the decoder. The number of different CNN SR models and/or sets of CNN set models may be different for different color components.

In one example, a rate distortion optimization (RDO) strategy or a distortion-minimizing strategy is used to determine the up-sampling for one video unit.

In one example, the different CNN-based SR models will be used to up-sample the current input (for example, luma reconstruction). Then, the PSNR values between the up-sampled reconstructions by different CNN-based SR models and the corresponding original input (the one which is not down-sampled and compressed) are calculated. The model which achieves the highest PSNR value will be chosen as the model for up-sampling. The index of that model may be signaled. In one example, the MS-SSIM value (instead of PSNR value) is used as the metric for comparison.

In one example, the different traditional up-sampling filters are compared and the one that achieves best quality metric is selected. In one example, the quality metric is PSNR.

In one example, the different CNN-based SR models and traditional filters are compared and the one achieves best quality metric is selected. In one example, the quality metric is PSNR.

The determination may be performed at the encoder or at the decoder. If the determination is at the decoder, the distortion may be calculated based on samples other than the current picture/slice//CTU/CTB, or any rectangular region.

Different quality metric(s) can be used as the metric for comparison. In one example, the quality metric is PSNR. In one example, the quality metric is SSIM. In one example, the quality metric is MS-SSIM. In one example, the quality metric is VMAF.

The position of SR is discussed in further detail below.

The super resolution (SR) process such as NN-based or Non-NN-based SR process may be placed before in-loop filters. In one example, the SR process may be invoked right after a block (e.g., a CTU/CTB) is reconstructed. In one example, the SR process may be invoked right after a region (e.g., a CTU row) is reconstructed.

The super resolution (SR) process such as NN-based or Non-NN-based SR process may be placed in different locations in the chain of in-loop filters.

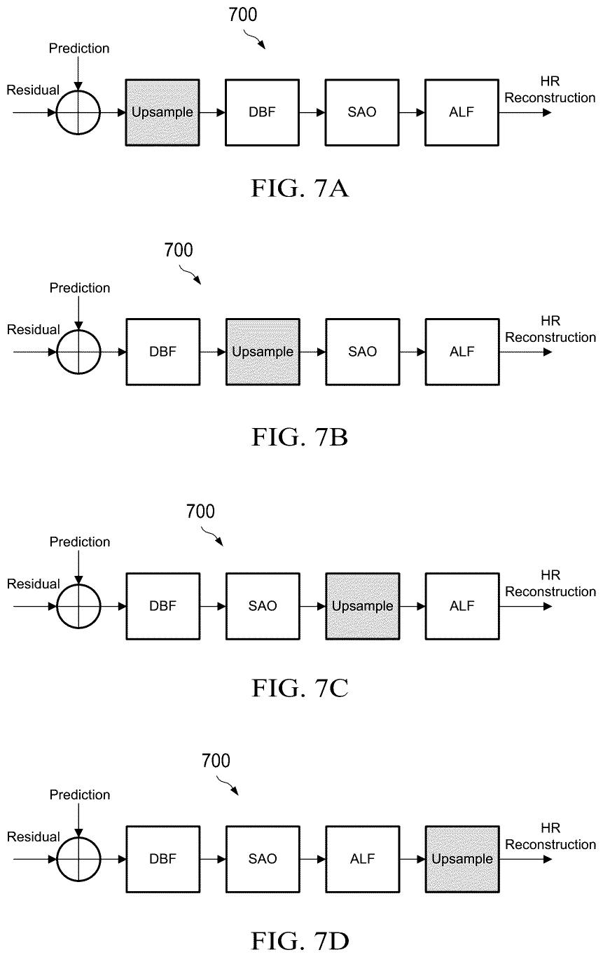

FIGS. 7A-7D illustrate examples 700 of positions for upsampling.

In one example, the SR process may be applied before or after a given in-loop filters. In one example, the SR process is placed before DBF as illustrated in FIG. 7A. In one example, the SR process is placed between DBF and SAO as illustrated in FIG. 7B. In one example, the SR process is placed between SAO and ALF as illustrated in FIG. 7C. In one example, the super resolution is placed after ALF as illustrated in FIG. 7D. In one example, the SR process is placed before SAO. In one example, the SR process is placed before ALF.

In one example, whether to apply SR before a given in-loop filter may depend on whether the loop-filter decision process is taking the original image into consideration.

Indication of the position of SR process may be signaled in the bitstream or determined on-the-fly according to decoded information.

The SR process such as NN-based or Non-NN-based SR process may be exclusively used with other coding tools such as in-loop filters, i.e., when the SR process is applied, then one or multiple kinds of the in-loop filters may not be applied any more, or vice versa.

In one example, the SR process may be used exclusively with at least one kind of in-loop filters. In one example, the original loop filters, such as DB, SAO, and ALF are all turned off when the SR process is applied. In one example, the SR process may be applied when ALF is disabled. In one example, the SR process may be applied to chroma components when cross-component ALF (CC-ALF) is disabled.

In one example, signalling of side information of an in-loop filtering method may be dependent on whether/how the SR process is applied.

In one example, whether/how the SR process is applied may be dependent on the usage of an in-loop filtering method.

The following examples involve the SR network structure.

The proposed NN-based (e.g., CNN-based) SR network comprises multiple convolutional layers. There is an up-sampling layer used in the proposed network to up-sample the resolution.

In one example, the de-convolution with stride of K greater than 1 (e.g., K=2) can be used for up-sampling. In one example, K may be dependent on decoded information (e.g., color format).

In one example, the pixel shuffling is used for up-sampling as shown in FIG. 4. Suppose the down- sampling ratio is K where the resolution of LR input is 1/K of the original input. The first 3×3 convolution is used to fuse the information from LR input and generate the feature maps. The output feature maps from the first convolutional layer then go through several sequentially stacked residual blocks, labeled RB. Feature maps are labeled M and R. The last convolutional layer takes the feature maps from the last residual block as input and produces R (e.g., R=K*K) feature maps. Finally, a shuffle layer is adopted to generate the filter image whose spatial resolution whose spatial resolution is the same with the original resolution.

In one example, the residual blocks may be used in the SR network. In one example, the residual blocks consist of three sequentially connected components as shown in FIG. 5: one convolutional layer, one PReLU activation function, and a convolutional layer. The input to the first convolutional layer is added to the output of the second convolutional layer.

The inputs of the NN-based (e.g., CNN-based) SR network can be different video units (e.g., sequence/picture/slice/tile/brick/subpicture/CTU/CTU row/one or multiple CUs or CTUs/CTBs, or any rectangular region) levels. In one example, the input of SR network can be a CTU block which is down-sampled. In one example, the input is the whole frame which is down-sampled.

The input of NN-based (e.g., CNN-based) SR network may be a combination of different color components. In one example, the input may be the luma component of reconstruction. In one example, the input may be the chroma components of reconstruction. In one example, the input may be both luma and chroma components of the same reconstruction.

In one example, the luma component may be used as the input and the output of the NN-based (e.g., CNN-based) SR network is the up-sampled chroma components.

In one example, the chroma components may be used as the input and the output of the NN-based (e.g., CNN-based) SR network is the up-sampled luma component.

The NN-based (e.g., CNN-based) SR network is not limited to up-sample the reconstructions. In one example, the decoded side information may be used as the input of NN-based (e.g., CNN-based) SR network for up-sampling. In one example, the prediction picture may be used as the input for up-sampling. The output of the network is the up-sampled prediction picture.

It is proposed that the coded (encoded/decoded) information can be utilized during the super resolution process.

In one example, the coded information could be used as inputs to NN-based SR solutions.

In one example, the coded information could be used to determine which SR solution to be applied.

In one example, the coded information may include the partition information, the prediction information, and the intra prediction mode, etc. In one example, the input includes the reconstructed low-resolution samples and other decoded information (e.g., the partition information, the prediction information, and the intra prediction mode). In one example, the partition information has the same resolution as the reconstructed low-resolution frame. Sample values in the partition are derived by averaging the reconstructed samples in a coding unit. In one example, the prediction information may be the generated prediction samples from intra prediction or intra block copy (IBC) prediction or inter-prediction. In one example, the intra prediction mode has the same resolution as the reconstructed low-resolution frame. Sample values in the intra prediction mode are derived by filling the intra prediction mode in the corresponding coding unit. In one example, the QP value information can be used as assistant information to improve the quality of up-sampled reconstruction. In one example, construct a QP map by filling a matrix with QP value and its spatial size is the same with other input data. The QP map will be fed into the network of super resolution.

The following examples involve the color components for input of the SR network.

Information related to a first color component may be utilized during the SR process applied to a second color component.

Information related to a first color component may be utilized as input for the SR process applied to a second color component.

Chroma information may be utilized as input for luma up-sampling process.

Luma information may be utilized as input for chroma up-sampling process. In one example, the luma reconstructed samples before the in-loop filters may be used. Alternatively, the luma reconstructed samples after the in-loop filters may be used. In one example, the input to the NN contains both chroma reconstructed samples and luma reconstructed samples. In one example, the luma information can be down sampled to the same resolution with chroma components. The down-sampled luma information will be concatenated with the chroma components. In one example, the down-sample method is bi-linear interpolation. In one example, the down-sample method is bi-cubic interpolation. In one example, the down-sample method is convolution with stride equal to the scaling ratio for original frame. In one example, the down-sample method is the inverse of pixel shuffle. A high-resolution block (HR block) with size 4×4×1 will be down-sampled to a low-resolution block (LR block) with size 2×2×4 will be up-sampled to. The font of first element in each channel of the LR block and the corresponding position. In one example, the down-sample method may depend on color format such as 4:2:0 or 4:2:2. In one example, the down-sample method may be signaled from the encoder to the decoder. Alternatively, furthermore, whether to apply the down-sample process may depend on the color format. In another example, the color format is 4:4:4 and no down-sampling is performed to the luma information.

In one example, the chroma reconstructed samples before the in-loop filters may be used. Alternatively, the chroma reconstructed samples after the in-loop filters may be used. In one example, the input to the NN contains both chroma reconstructed samples and luma reconstructed samples. In one example, the input to the NN contains both chroma reconstructed samples and luma prediction samples.

In one example, one chroma component (e.g., Cb) information may be utilized as input for the other chroma component (e.g., Cr) up-sampling process.

In one example, the input includes the reconstructed samples and the decoded information (e.g., the mode information, and the prediction information). In one example, the mode information is a binary frame with each value indicating if the sample belongs to a skip coded unit or not. In one example, the prediction information is derived via the motion compensation for inter coded coding unit.

In one example, the prediction information may be utilized as input for the SR process applied to the reconstruction.

In one example, the luma information of prediction pictures may be utilized as input for the SR process of the luma component of reconstructions.

In one example, the luma information of prediction pictures may be utilized as input for the SR process of the chroma component of reconstructions.

In one example, the chroma information of prediction pictures may be utilized as input for the SR process of the chroma component of reconstructions.

In one example, the luma and chroma information of prediction pictures may be utilized together as input for the SR process of the reconstruction (for example, luma reconstruction).

In case prediction information is unavailable (such as the coding mode is palette or PCM), the prediction samples are padded.

In one example, the partition information may be utilized as input for the SR process applied to the reconstruction.

In one example, the partition information has the same resolution as the reconstructed low-resolution frame. Sample values in the partition are derived by averaging the reconstructed samples in a coding unit.

In one example, the intra prediction mode information may be utilized as input for the SR process applied to the reconstruction.

In one example, the intra prediction mode of current sample via intra or inter prediction can be used. In one example, the intra prediction mode matrix, which is the same resolution as the reconstruction, is constructed as one input for the SR process. For each sample in the intra prediction mode matrix, the value comes from the intra prediction mode of the corresponding CU.

In one example, the above method may be applied to a specific picture/slice type, such as I slice/pictures, e.g., a NN-based SR model is trained to up-sample the reconstructed samples in I slice.

In one example, the above method may be applied to B/P slice/pictures, e.g., a NN-based SR model is trained for to up-sample the reconstructed samples in B slice or P slice.

### On Processing Unit of SR

Super resolution/up-sampling process may be performed at a SR unit level wherein the SR unit convers more than one sample/pixel.

In one example, the SR unit may be the same as the video unit wherein down-sampling process is invoked.

In one example, the SR unit may be different from the video unit wherein down-sampling process is invoked. In one example, even the down-sampling is performed in the picture/slice/tile level, the SR unit may be a block (e.g., a CTU). In one example, even the down-sampling is performed in the CTU/CTB level, the SR unit may be CTU row or multiple CTU/CTBs.

Alternatively, furthermore, for the NN-based SR methods, the inputs to the network may be set to the SR unit.

Alternatively, furthermore, for the NN-based SR methods, the inputs to the network may be set to a region containing the SR unit to be up-sampled and other samples/pixels.

In one example, the SR unit may be indicated in a bitstream or pre-defined.

For two SR units, the super resolution methods/up-sampling methods may be different. In one example, the super resolution methods/up-sampling methods may include the NN-based solution and the non-NN-based solution (e.g., traditional up-sampling filtering methods).

The inputs of SR network can be at different video units (e.g., sequence/picture/slice/tile/brick/subpicture/CTU/CTU row/one or multiple CUs or CTUs/CTBs, or any region covers more than one sample/pixel) level. In one example, the input of SR network can be a CTU block which is down- sampled. In one example, the input is the whole frame which is down-sampled.

The CNN-based SR models can be used to up-sample the different video unit level. In one example, the CNN-based SR models are trained on the frame-level data and is used to up-sample the frame-level input. In one example, the CNN-based SR models are trained on the frame-level data and is used to up-sample the CTU-level input. In one example, the CNN-based SR models are trained on the CTU-level data and is used to up-sample the frame-level input.

In one example, the CNN-based SR models are trained on the CTU-level data and is used to up-sample the CTU-level input.

The following examples involve the side information for input of the SR network.

The down-sampling ratio of a video unit may be treated as inputs of the SR network.

Alternatively, furthermore, the convolution layer may be configured with a stride which is dependent on the down sampling ratio.

The down-sampling ratio for the input of SR network can be any positive integers. Alternatively, furthermore, and the minimal spatial resolution of the input shall be 1×1.

The down-sampling ratio for the input of SR network may be a ratio of any two positive integers, such as 3:2.

The horizontal down-sampling ratio can vertical down-sampling ratio may be the same, or they may be different.

It is proposed that the encoded/decoded information can be utilized during the up-sampling process.

In one example, the encoded/decoded information may be used as the inputs of the super resolution network.

In one example, the encoded/decoded information may include but not limited to prediction signal, partition structure, intra prediction mode.

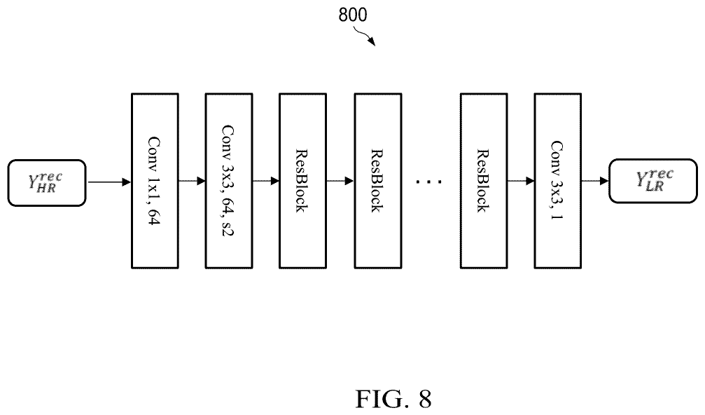

FIG. 8 illustrates an example downsampling network 800. An embodiment is stated as follows. First, given one sequence for compression, the down-sampling is performed on the picture-level. Second, the current frame is down-sampled with 2× down-sampling ratio before encoding. (Suppose there are 2× and 4× down-sampling ratios to be determined). In one example, the NN-based down-sampling method illustrated in FIG. 8 may be used. FIG. 8 shows the down-sampling network for luma component, but it may be used for chroma component. Besides, the down-sampling ratio in FIG. 8 is 2, and so to provide performance of 4× down-sampling, the network may be applied twice. Third, the down-sampled frame is encoded. Fourth, the low-resolution reconstruction is up-sampled to the original resolution. In one example, the up-sampling network may use the network illustrated in FIG. 4. Fifth, the PSNR value for the 2× down-sampling is calculated. Sixth, the foregoing steps 2-5 are repeated to determine the PSNR value(s) for 4× down-sampling. Seventh, the PSNRs for different down-samplings are compared, and the greatest PSNR is used for the actual down-sampling being performed. In one example, the 2× down-sampling ratio may achieve a higher PSNR value. In this condition, the current frame will be down-sampled with 2× ratio for real encoding. Finally, the foregoing steps 2-7 are repeated for next frames.

This embodiment relates to the example items summarized above in Section 5.

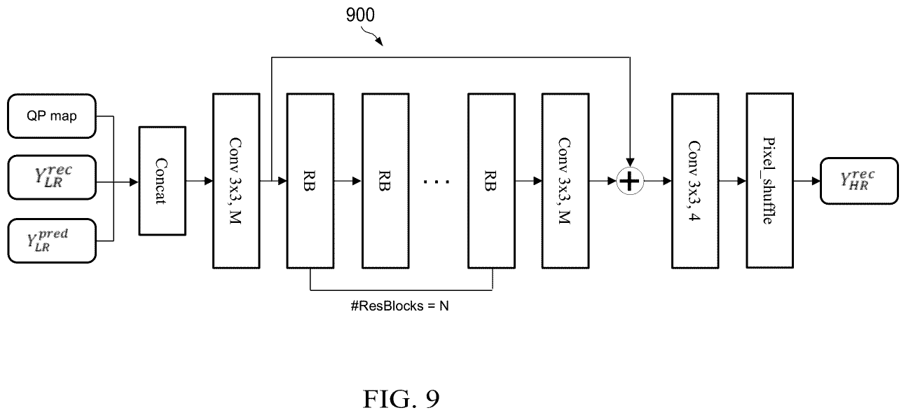

FIG. 9 illustrates an example model for luma up-sampling 900.

In the example model 900, the rescaling operation is applied on the luma component only, to avoid the loss on chroma components, which is usually observed in super resolution methods. The down-sampled luma component and no-changed chroma components are coded with the 4:4:4 color format.

The up-sampling model for the luma component is illustrated in FIG. 9. The input to the model consists of three parts, i.e., the low-resolution luma reconstruction samples, the low-resolution luma prediction samples, and the QP map filled with the QP value. Those three parts are concatenated together and then fed into the first convolutional layer. The output from the first layer further goes through several residual blocks and one additional convolutional layer. Then, a shuffle layer generates the high-resolution reconstruction from the output of the last convolutional layer. To keep the complexity tolerable, in this example, N is set equal to 16, and M is set equal to 96 and 64 for processing intra and inter slices, respectively.

The CNN-based in-loop filter from JVET-AA0111 is used. To achieve better tradeoff between luma and chroma coding performance, the example sets chromaQpOffset=−7 and luma-only down-sampling is only performed when QP>32.

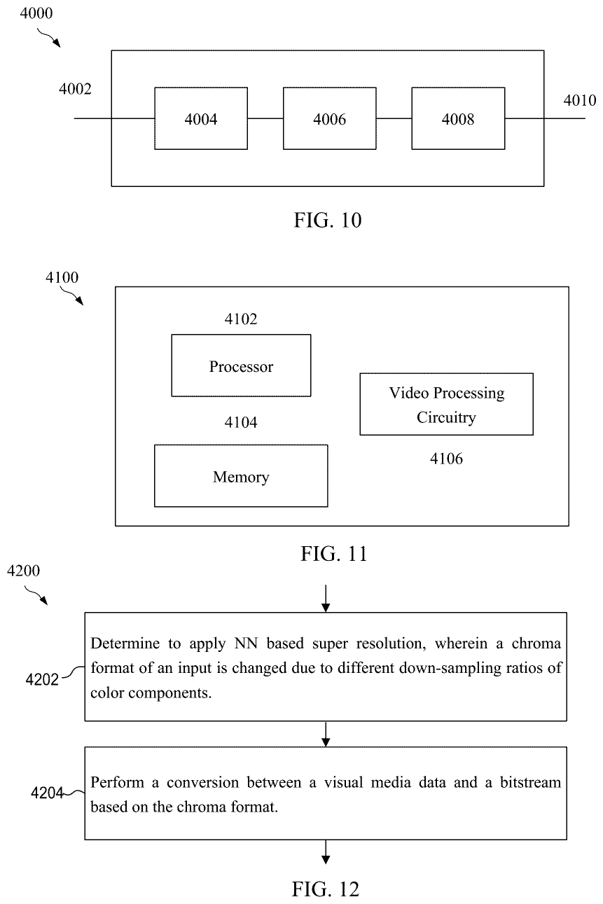

FIG. 10 is a block diagram showing an example video processing system 4000 in which various techniques disclosed herein may be implemented. Various implementations may include some or all of the components of the system 4000. The system 4000 may include input 4002 for receiving video content. The video content may be received in a raw or uncompressed format, e.g., 8- or 10-bit multi-component pixel values, or may be in a compressed or encoded format. The input 4002 may represent a network interface, a peripheral bus interface, or a storage interface. Examples of network interface include wired interfaces such as Ethernet, passive optical network (PON), etc. and wireless interfaces such as Wi-Fi or cellular interfaces.

The system 4000 may include a coding component 4004 that may implement the various coding or encoding methods described in the present document. The coding component 4004 may reduce the average bitrate of video from the input 4002 to the output of the coding component 4004 to produce a coded representation of the video. The coding techniques are therefore sometimes called video compression or video transcoding techniques. The output of the coding component 4004 may be either stored, or transmitted via a communication connected, as represented by the component 4006. The stored or communicated bitstream (or coded) representation of the video received at the input 4002 may be used by a component 4008 for generating pixel values or displayable video that is sent to a display interface 4010. The process of generating user-viewable video from the bitstream representation is sometimes called video decompression. Furthermore, while certain video processing operations are referred to as “coding” operations or tools, it will be appreciated that the coding tools or operations are used at an encoder and corresponding decoding tools or operations that reverse the results of the coding will be performed by a decoder.

Examples of a peripheral bus interface or a display interface may include universal serial bus (USB) or high definition multimedia interface (HDMI) or DisplayPort, and so on. Examples of storage interfaces include serial advanced technology attachment (SATA), peripheral component interconnect (PCI), integrated drive electronics (IDE) interface, and the like. The techniques described in the present document may be embodied in various electronic devices such as mobile phones, laptops, smartphones or other devices that are capable of performing digital data processing and/or video display.

FIG. 11 is a block diagram of an example video processing apparatus 4100. The apparatus 4100 may be used to implement one or more of the methods described herein. The apparatus 4100 may be embodied in a smartphone, tablet, computer, Internet of Things (IOT) receiver, and so on. The apparatus 4100 may include one or more processors 4102, one or more memories 4104 and video processing circuitry 4106. The processor(s) 4102 may be configured to implement one or more methods described in the present document. The memory (memories) 4104 may be used for storing data and code used for implementing the methods and techniques described herein. The video processing circuitry 4106 may be used to implement, in hardware circuitry, some techniques described in the present document. In some embodiments, the video processing circuitry 4106 may be at least partly included in the processor 4102, e.g., a graphics co-processor.

FIG. 12 is a flowchart for an example method 4200 of video processing. The method 4200 includes determining to apply neural network (NN) based super resolution at step 4202. A chroma format of an input is changed due to different down-sampling ratios of color components. A conversion is performed between a visual media data and a bitstream based on the chroma format at step 4204. The conversion of step 4204 may include encoding at an encoder or decoding at a decoder, depending on the example.

It should be noted that the method 4200 can be implemented in an apparatus for processing video data comprising a processor and a non-transitory memory with instructions thereon, such as video encoder 4400, video decoder 4500, and/or encoder 4600. In such a case, the instructions upon execution by the processor, cause the processor to perform the method 4200. Further, the method 4200 can be performed by a non-transitory computer readable medium comprising a computer program product for use by a video coding device. The computer program product comprises computer executable instructions stored on the non-transitory computer readable medium such that when executed by a processor cause the video coding device to perform the method 4200.

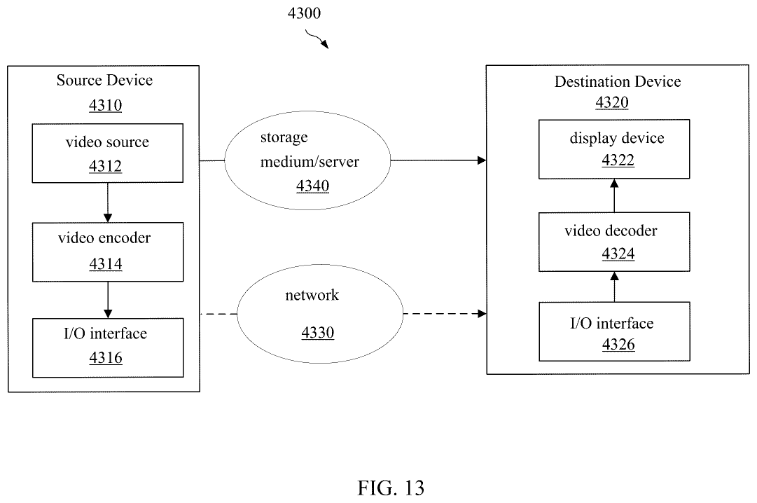

FIG. 13 is a block diagram that illustrates an example video coding system 4300 that may utilize the techniques of this disclosure. The video coding system 4300 may include a source device 4310 and a destination device 4320. Source device 4310 generates encoded video data which may be referred to as a video encoding device. Destination device 4320 may decode the encoded video data generated by source device 4310 which may be referred to as a video decoding device.

Source device 4310 may include a video source 4312, a video encoder 4314, and an input/output (I/O) interface 4316. Video source 4312 may include a source such as a video capture device, an interface to receive video data from a video content provider, and/or a computer graphics system for generating video data, or a combination of such sources. The video data may comprise one or more pictures. Video encoder 4314 encodes the video data from video source 4312 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. I/O interface 4316 may include a modulator/demodulator (modem) and/or a transmitter. The encoded video data may be transmitted directly to destination device 4320 via I/O interface 4316 through network 4330. The encoded video data may also be stored onto a storage medium/server 4340 for access by destination device 4320.

Destination device 4320 may include an I/O interface 4326, a video decoder 4324, and a display device 4322. I/O interface 4326 may include a receiver and/or a modem. I/O interface 4326 may acquire encoded video data from the source device 4310 or the storage medium/server 4340. Video decoder 4324 may decode the encoded video data. Display device 4322 may display the decoded video data to a user. Display device 4322 may be integrated with the destination device 4320, or may be external to destination device 4320, which can be configured to interface with an external display device.

Video encoder 4314 and video decoder 4324 may operate according to a video compression standard, such as HEVC, VVC, and other current and/or further standards.

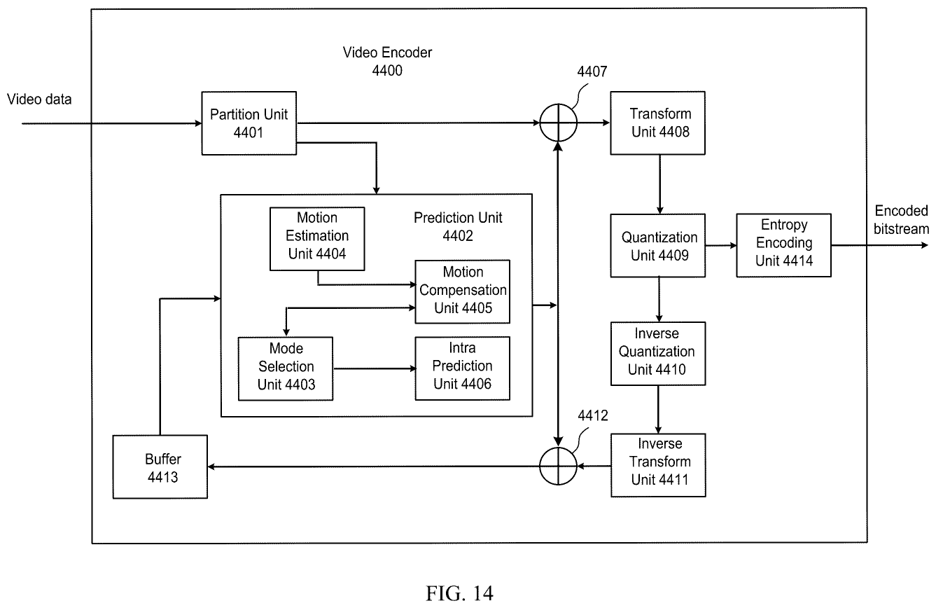

FIG. 14 is a block diagram illustrating an example of video encoder 4400, which may be video encoder 4314 in the system 4300 illustrated in FIG. 13. Video encoder 4400 may be configured to perform any or all of the techniques of this disclosure. The video encoder 4400 includes a plurality of functional components. The techniques described in this disclosure may be shared among the various components of video encoder 4400. In some examples, a processor may be configured to perform any or all of the techniques described in this disclosure.

The functional components of video encoder 4400 may include a partition unit 4401; a prediction unit 4402, which may include a mode select unit 4403, a motion estimation unit 4404, a motion compensation unit 4405, and an intra prediction unit 4406; a residual generation unit 4407; a transform processing unit 4408; a quantization unit 4409; an inverse quantization unit 4410; an inverse transform unit 4411; a reconstruction unit 4412; a buffer 4413; and an entropy encoding unit 4414.

In other examples, video encoder 4400 may include more, fewer, or different functional components. In an example, prediction unit 4402 may include an intra block copy (IBC) unit. The IBC unit may perform prediction in an IBC mode in which at least one reference picture is a picture where the current video block is located.

Furthermore, some components, such as motion estimation unit 4404 and motion compensation unit 4405 may be highly integrated, but are represented in the example of video encoder 4400 separately for purposes of explanation.

Partition unit 4401 may partition a picture into one or more video blocks. Video encoder 4400 and video decoder 4500 may support various video block sizes.

Mode select unit 4403 may select one of the coding modes, intra or inter, e.g., based on error results, and provide the resulting intra or inter coded block to a residual generation unit 4407 to generate residual block data and to a reconstruction unit 4412 to reconstruct the encoded block for use as a reference picture. In some examples, mode select unit 4403 may select a combination of intra and inter prediction (CIIP) mode in which the prediction is based on an inter prediction signal and an intra prediction signal. Mode select unit 4403 may also select a resolution for a motion vector (e.g., a sub-pixel or integer pixel precision) for the block in the case of inter prediction.

To perform inter prediction on a current video block, motion estimation unit 4404 may generate motion information for the current video block by comparing one or more reference frames from buffer 4413 to the current video block. Motion compensation unit 4405 may determine a predicted video block for the current video block based on the motion information and decoded samples of pictures from buffer 4413 other than the picture associated with the current video block.

Motion estimation unit 4404 and motion compensation unit 4405 may perform different operations for a current video block, for example, depending on whether the current video block is in an I slice, a P slice, or a B slice.

In some examples, motion estimation unit 4404 may perform uni-directional prediction for the current video block, and motion estimation unit 4404 may search reference pictures of list 0 or list 1 for a reference video block for the current video block. Motion estimation unit 4404 may then generate a reference index that indicates the reference picture in list 0 or list 1 that contains the reference video block and a motion vector that indicates a spatial displacement between the current video block and the reference video block. Motion estimation unit 4404 may output the reference index, a prediction direction indicator, and the motion vector as the motion information of the current video block. Motion compensation unit 4405 may generate the predicted video block of the current block based on the reference video block indicated by the motion information of the current video block.

In other examples, motion estimation unit 4404 may perform bi-directional prediction for the current video block, motion estimation unit 4404 may search the reference pictures in list 0 for a reference video block for the current video block and may also search the reference pictures in list 1 for another reference video block for the current video block. Motion estimation unit 4404 may then generate reference indexes that indicate the reference pictures in list 0 and list 1 containing the reference video blocks and motion vectors that indicate spatial displacements between the reference video blocks and the current video block. Motion estimation unit 4404 may output the reference indexes and the motion vectors of the current video block as the motion information of the current video block. Motion compensation unit 4405 may generate the predicted video block of the current video block based on the reference video blocks indicated by the motion information of the current video block.

In some examples, motion estimation unit 4404 may output a full set of motion information for decoding processing of a decoder. In some examples, motion estimation unit 4404 may not output a full set of motion information for the current video. Rather, motion estimation unit 4404 may signal the motion information of the current video block with reference to the motion information of another video block. For example, motion estimation unit 4404 may determine that the motion information of the current video block is sufficiently similar to the motion information of a neighboring video block.

In one example, motion estimation unit 4404 may indicate, in a syntax structure associated with the current video block, a value that indicates to the video decoder 4500 that the current video block has the same motion information as another video block.

In another example, motion estimation unit 4404 may identify, in a syntax structure associated with the current video block, another video block and a motion vector difference (MVD). The motion vector difference indicates a difference between the motion vector of the current video block and the motion vector of the indicated video block. The video decoder 4500 may use the motion vector of the indicated video block and the motion vector difference to determine the motion vector of the current video block.

As discussed above, video encoder 4400 may predictively signal the motion vector. Two examples of predictive signaling techniques that may be implemented by video encoder 4400 include advanced motion vector prediction (AMVP) and merge mode signaling.

Intra prediction unit 4406 may perform intra prediction on the current video block. When intra prediction unit 4406 performs intra prediction on the current video block, intra prediction unit 4406 may generate prediction data for the current video block based on decoded samples of other video blocks in the same picture. The prediction data for the current video block may include a predicted video block and various syntax elements.

Residual generation unit 4407 may generate residual data for the current video block by subtracting the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and residual generation unit 4407 may not perform the subtracting operation.

Transform processing unit 4408 may generate one or more transform coefficient video blocks for the current video block by applying one or more transforms to a residual video block associated with the current video block.

After transform processing unit 4408 generates a transform coefficient video block associated with the current video block, quantization unit 4409 may quantize the transform coefficient video block associated with the current video block based on one or more quantization parameter (QP) values associated with the current video block.

Inverse quantization unit 4410 and inverse transform unit 4411 may apply inverse quantization and inverse transforms to the transform coefficient video block, respectively, to reconstruct a residual video block from the transform coefficient video block. Reconstruction unit 4412 may add the reconstructed residual video block to corresponding samples from one or more predicted video blocks generated by the prediction unit 4402 to produce a reconstructed video block associated with the current block for storage in the buffer 4413.

After reconstruction unit 4412 reconstructs the video block, the loop filtering operation may be performed to reduce video blocking artifacts in the video block.

Entropy encoding unit 4414 may receive data from other functional components of the video encoder 4400. When entropy encoding unit 4414 receives the data, entropy encoding unit 4414 may perform one or more entropy encoding operations to generate entropy encoded data and output a bitstream that includes the entropy encoded data.

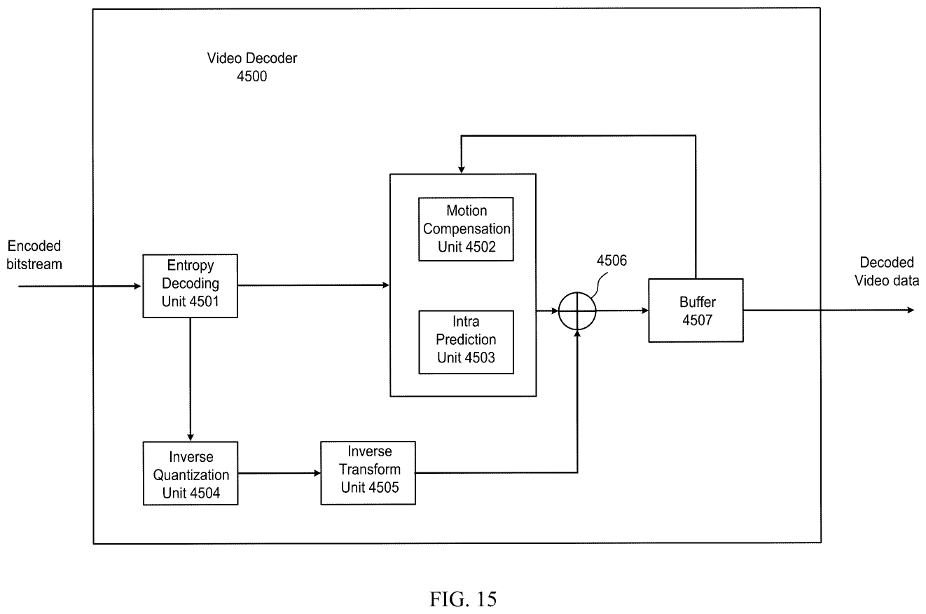

FIG. 15 is a block diagram illustrating an example of video decoder 4500 which may be video decoder 4324 in the system 4300 illustrated in FIG. 13. The video decoder 4500 may be configured to perform any or all of the techniques of this disclosure. In the example shown, the video decoder 4500 includes a plurality of functional components. The techniques described in this disclosure may be shared among the various components of the video decoder 4500. In some examples, a processor may be configured to perform any or all of the techniques described in this disclosure.

In the example shown, video decoder 4500 includes an entropy decoding unit 4501, a motion compensation unit 4502, an intra prediction unit 4503, an inverse quantization unit 4504, an inverse transformation unit 4505, a reconstruction unit 4506, and a buffer 4507. Video decoder 4500 may, in some examples, perform a decoding pass generally reciprocal to the encoding pass described with respect to video encoder 4400.

Entropy decoding unit 4501 may retrieve an encoded bitstream. The encoded bitstream may include entropy coded video data (e.g., encoded blocks of video data). Entropy decoding unit 4501 may decode the entropy coded video data, and from the entropy decoded video data, motion compensation unit 4502 may determine motion information including motion vectors, motion vector precision, reference picture list indexes, and other motion information. Motion compensation unit 4502 may, for example, determine such information by performing the AMVP and merge mode.

Motion compensation unit 4502 may produce motion compensated blocks, possibly performing interpolation based on interpolation filters. Identifiers for interpolation filters to be used with sub-pixel precision may be included in the syntax elements.

Motion compensation unit 4502 may use interpolation filters as used by video encoder 4400 during encoding of the video block to calculate interpolated values for sub-integer pixels of a reference block. Motion compensation unit 4502 may determine the interpolation filters used by video encoder 4400 according to received syntax information and use the interpolation filters to produce predictive blocks.

Motion compensation unit 4502 may use some of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter coded block, and other information to decode the encoded video sequence.

Intra prediction unit 4503 may use intra prediction modes for example received in the bitstream to form a prediction block from spatially adjacent blocks. Inverse quantization unit 4504 inverse quantizes, i.e., de-quantizes, the quantized video block coefficients provided in the bitstream and decoded by entropy decoding unit 4501. Inverse transform unit 4505 applies an inverse transform.

Reconstruction unit 4506 may sum the residual blocks with the corresponding prediction blocks generated by motion compensation unit 4502 or intra prediction unit 4503 to form decoded blocks. If desired, a deblocking filter may also be applied to filter the decoded blocks in order to remove blockiness artifacts. The decoded video blocks are then stored in buffer 4507, which provides reference blocks for subsequent motion compensation/intra prediction and also produces decoded video for presentation on a display device.

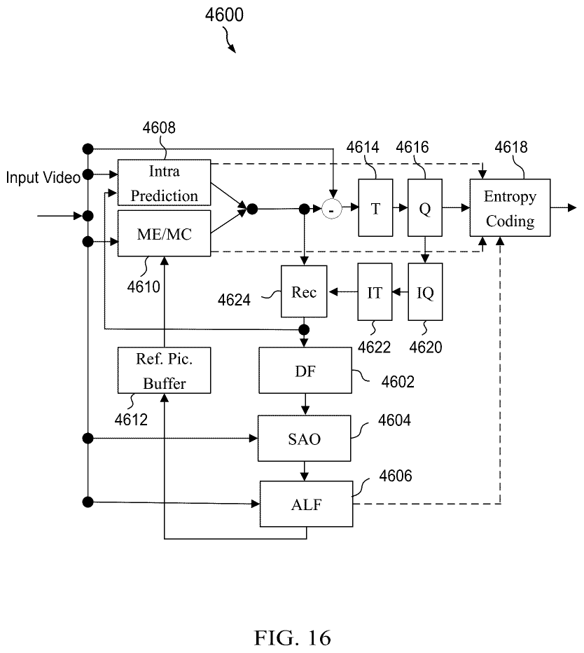

FIG. 16 is a schematic diagram of an example encoder 4600. The encoder 4600 is suitable for implementing the techniques of VVC. The encoder 4600 includes three in-loop filters, namely a deblocking filter (DF) 4602, a sample adaptive offset (SAO) 4604, and an adaptive loop filter (ALF) 4606. Unlike the DF 4602, which uses predefined filters, the SAO 4604 and the ALF 4606 utilize the original samples of the current picture to reduce the mean square errors between the original samples and the reconstructed samples by adding an offset and by applying a finite impulse response (FIR) filter, respectively, with coded side information signaling the offsets and filter coefficients. The ALF 4606 is located at the last processing stage of each picture and can be regarded as a tool trying to catch and fix artifacts created by the previous stages.

The encoder 4600 further includes an intra prediction component 4608 and a motion estimation/compensation (ME/MC) component 4610 configured to receive input video. The intra prediction component 4608 is configured to perform intra prediction, while the ME/MC component 4610 is configured to utilize reference pictures obtained from a reference picture buffer 4612 to perform inter prediction. Residual blocks from inter prediction or intra prediction are fed into a transform (T) component 4614 and a quantization (Q) component 4616 to generate quantized residual transform coefficients, which are fed into an entropy coding component 4618. The entropy coding component 4618 entropy codes the prediction results and the quantized transform coefficients and transmits the same toward a video decoder (not shown). Quantization components output from the quantization component 4616 may be fed into an inverse quantization (IQ) components 4620, an inverse transform component 4622, and a reconstruction (REC) component 4624. The REC component 4624 is able to output images to the DF 4602, the SAO 4604, and the ALF 4606 for filtering prior to those images being stored in the reference picture buffer 4612.

A listing of solutions preferred by some examples is provided next.

The following solutions show examples of embodiments discussed herein.
1. A method for processing video data comprising: determining to apply neural network (NN) based super resolution, wherein a chroma format of an input is changed due to different down-sampling ratios of color components; and performing a conversion between a visual media data and a bitstream based on the chroma format.
2. The method of solution 1, wherein the chroma format of the input is changed from YUV 4:2:0 to YUV 4:4:4 when a down-sampling ratio is 2 for a luma component and a down-sampling ratio is 1 for chroma components.
3. The method of any of solutions 1-2, wherein the luma components is down-sampled at a video unit, and wherein the video unit is a sequence, a picture, a slice, a tile, a brick, a subpicture, a coding tree unit (CTU), a CTU row, one or more coding units (CUs), one or more CTUs, one or more coding tree blocks (CTBs), or combinations thereof.
4. The method of any of solutions 1-3, wherein a down-sampled luma components is one frame or one CTU.
5. The method of any of solutions 1-4, wherein the chroma format as changed is used for compression in an encoder.
6. The method of any of solutions 1-5, wherein the chroma format of the input is changed from YUV 4:2:0 to YUV 4:4:4, and wherein YUV 4:4:4 is used as the chroma format for compression.
7. The method of any of solutions 1-6, wherein information to recover an original chroma format is signaled at a video unit level.
8. The method of any of solutions 1-7, wherein down-sampling ratios for all color components are signaled in a sequence parameter set (SPS), a picture parameter set (PPS), a picture header, a slice header, a CTU, a CTB, or combinations thereof.
9. The method of any of solutions 1-8, wherein an original chroma format is signaled in a SPS, a PPS, a picture header, a slice header, a CTU, a CTB, or combinations thereof.
10. The method of any of solutions 1-9, wherein neural network-based tools are used in an encoder.
11. The method of any of solutions 1-10, wherein neural network-based tools are used in a decoder.
12. The method of any of solutions 1-11, wherein a neural network-based in-loop filter is used.
13. The method of any of solutions 1-12, wherein two neural network-based in-loop filters are applied to a down-sampled luma reconstruction and a chroma reconstruction, respectively.
14. The method of any of solutions 1-13, wherein a down-sampled luma reconstruction is concatenated with a chroma reconstruction and used as an input of a neural network-based in-loop filter for chroma.
15. The method of any of solutions 1-14, wherein a neural network-based super resolution is applied to luma components of a reconstructed YUV as a post filter to recover an original chroma format.
16. The method of any of solutions 1-15, wherein neural network-based super resolution is applied before in-loop filters to recover an original chroma format.
17. An apparatus for processing video data comprising: a processor; and a non-transitory memory with instructions thereon, wherein the instructions upon execution by the processor, cause the processor to perform the method of any of solutions 1-16.
18. A non-transitory computer readable medium comprising a computer program product for use by a video coding device, the computer program product comprising computer executable instructions stored on the non-transitory computer readable medium such that when executed by a processor cause the video coding device to perform the method of any of solutions 1-16.
19. A non-transitory computer-readable recording medium storing a bitstream of a video which is generated by a method performed by a video processing apparatus, wherein the method comprises: determining to apply neural network (NN) based super resolution, wherein a chroma format of an input is changed due to different down-sampling ratios of color components; and generating the bitstream based on the determining.
20. A method for storing bitstream of a video comprising: determining to apply neural network (NN) based super resolution, wherein a chroma format of an input is changed due to different down-sampling ratios of color components; generating the bitstream based on the determining; and storing the bitstream in a non-transitory computer-readable recording medium.
21. A method, apparatus, or system described in the present document.

In the solutions described herein, an encoder may conform to the format rule by producing a coded representation according to the format rule. In the solutions described herein, a decoder may use the format rule to parse syntax elements in the coded representation with the knowledge of presence and absence of syntax elements according to the format rule to produce decoded video.

In the present document, the term “video processing” may refer to video encoding, video decoding, video compression or video decompression. For example, video compression algorithms may be applied during conversion from pixel representation of a video to a corresponding bitstream representation or vice versa. The bitstream representation of a current video block may, for example, correspond to bits that are either co-located or spread in different places within the bitstream, as is defined by the syntax. For example, a macroblock may be encoded in terms of transformed and coded error residual values and also using bits in headers and other fields in the bitstream. Furthermore, during conversion, a decoder may parse a bitstream with the knowledge that some fields may be present, or absent, based on the determination, as is described in the above solutions. Similarly, an encoder may determine that certain syntax fields are or are not to be included and generate the coded representation accordingly by including or excluding the syntax fields from the coded representation.

The disclosed and other solutions, examples, embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., a field-programmable gate array (FPGA) or an application-specific integrated circuit (ASIC).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., erasable programmable read-only memory (EPROM), electrically erasable programmable read-only memory (EEPROM), and flash memory devices; magnetic disks, e.g., internal hard disks or removable disks; magneto optical disks; and compact disc read-only memory (CD ROM) and digital versatile disc-read only memory (DVD-ROM) disks. The processor and the memory can be supplemented by, or incorporated in, special purpose logic circuitry.

While the present disclosure contains many specifics, these should not be construed as limitations on the scope of any subject matter or of what may be claimed, but rather as descriptions of features that may be specific to particular embodiments of particular techniques. Certain features that are described in the present disclosure in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in the present disclosure should not be understood as requiring such separation in all embodiments.

Only a few implementations and examples are described and other implementations, enhancements and variations can be made based on what is described and illustrated in the present disclosure.

A first component is directly coupled to a second component when there are no intervening components, except for a line, a trace, or another medium between the first component and the second component. The first component is indirectly coupled to the second component when there are intervening components other than a line, a trace, or another medium between the first component and the second component. The term “coupled” and its variants include both directly coupled and indirectly coupled. The use of the term “about” means a range including ±10% of the subsequent number unless otherwise stated.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled may be directly connected or may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method of processing video data, comprising:
determining to apply neural network (NN) based super resolution; and
performing a conversion between a current video block of a video and a bitstream of the video based on the determining.

2. The method of claim 1, wherein at least one frame in a sequence of the video is performed with a down- sampling process,
wherein an indication of a down-sampling model is included in a sequence header, a sequence parameter set (SPS), a picture parameter set (PPS), a picture header, a slice header, a coding tree unit (CTU), a coding tree block (CTB), or a rectangle region of the bitstream,
wherein the down-sampling model comprises a filter,
wherein different down-sampling models are applied for different color components,
wherein the down-sampling model is required by a decoder side and is informed to an encoder side in an inter-active application, and
wherein the down-sampling model is NN based, and the NN is convolutional neural network (CNN).

3. The method of claim 2, wherein a discrete cosine transform interpolation filter (DCTIF) or bilinear interpolation or bicubic interpolation is used for the down-sampling process, and
wherein an index indicating a down-sampling filter and/or at least one coefficient of the down-sampling filter are included in the bitstream.

4. The method of claim 2, wherein the down-sampling model comprises at least one down-sampling layer, wherein a convolution with stride of K is used as the down-sampling layer and a down-sampling ratio is K, where K32 2, and
wherein a pixel-unshuffling method followed by a convolution with stride of 1 is used for the down-sampling process.

5. The method of claim 2, wherein a series of down-sampling processes are used for achieving a down-sampling ratio,
wherein two convolution layers with stride of K are used in one network, and a down-sampling ratio is 4,where K32 2, and
wherein two down-sampling filters are used for the down-sampling ratio of 4, and the down-sampling ratio of each down-sampling filter is 2.

6. The method of claim 2, wherein a filter and the down-sampling model that is CNN based are combined for a down-sampling ratio,
wherein the filter is used followed by the down-sampling model that is CNN based, and
wherein the filter achieves 2× down-sampling and the down-sampling model that is CNN based achieves 2× down-sampling, so that an input is down-sampled by 4×.

7. The method of claim 2, wherein when down-sampling an input video unit level, the down-sampling model is chosen by comparing different down-sampling models,
wherein in case of there being three down-sampling models that are CNN based, for one input, the three down-sampling models down-sample the input, respectively, down-sampled reconstruction is up-sampled to an original resolution, and a quality metric is utilized to measure three up-sampled results, so that the down-sampling model that achieves a best performance is utilized as an implemented down-sampling, wherein the quality metric comprises multi-scale structural similarity index measure (MS-SSIM) or peak signal-to-noise ratio (PSNR), and
wherein indices of the down-sampling models are signaled to an encoder or a decoder.

8. The method of claim 2, wherein the indication of the down-sampling model is signaled to a decoder,
wherein for one video unit level, an index of a chosen down-sampling model is signaled to the decoder, and
wherein different CTUs within one frame use different down-sampling models, and all indices of corresponding down-sampling models are signaled to the decoder.

9. The method of claim 2, wherein an input of the down-sampling model is at a video unit level, and the video unit comprises at least one of: a sequence, a picture, a slice, a tile, a brick, a subpicture, a CTU, a CTU row, one or more coding units (CUs), one or more CTUs, one or more CTBs, or
wherein the input is a frame level with a size of an original resolution of the frame level, or
wherein the input is one CTU level with a size of 128x128, or
wherein the input is a block within one frame whose size is not limited, or
wherein the input is a block with a spatial size (M, N), where M=256, N=128.

10. The method of claim 2, wherein down-sampling ratios are different for all video unit levels, and a video unit comprises at least one of: a sequence, a picture, a slice, a tile, a brick, a subpicture, a CTU, a CTU row, one or more coding units (CUs), one or more CTUs, one or more CTBs,
wherein a down-sample ratio is 2 for all frames of one sequence, or the down-sample ratio is 2 for all CTUs of one frame, or the down-sample ratio is 2 for a first frame and is 4 for a next frame, or the down-sample ratio is 2 for one frame and is 4 for one CTU in a same frame so that the CTU is down-sampled by 4×, and
wherein a combination of down-sampling ratios for different video unit levels is used.

11. The method of claim 2, wherein down-sampling ratios are different for all components of an input video unit level, or
wherein a down-sampling ratio is 2 for both luma component and chroma component, or
wherein the down-sampling ratio is 2 for the luma component and is 4 for the chroma component.

12. The method of claim 2, wherein a down-sampling ratio is 1 which indicates that no down-sampling is performed, and
wherein the down-sampling ratio is applied at all video unit levels, and a video unit comprises at least one of: a sequence, a picture, a slice, a tile, a brick, a subpicture, a CTU, a CTU row, one or more coding units (CUs), one or more CTUs, one or more CTBs.

13. The method of claim 2, wherein a down-sampling ratio is determined by comparison,
wherein in case of there being 2× and 4× down-sampling ratios for one frame that are available, an encoder compresses the frame with 2× down-sampling and then compresses the frame with 4× down-sampling, up-samples low-resolution reconstruction with a same up-sampling model, and calculates a quality metric of each result, so that the down-sampling ratio that achieves a best reconstruction quality is chosen as an implemented down-sampling ratio for compression, wherein the quality metric comprises multi-scale structural similarity index measure (MS-SSIM) or peak signal-to-noise ratio (PSNR),
wherein determination of the down-sampling ratio is performed at an encoder or at a decoder, wherein in case that the determination of the down-sampling ratio is performed at the decoder, distortion is calculated based on samples other than a current picture, a current slice, a current CTU, a current CTB, or a current rectangle region,
wherein different quality metrics are used as metric for the comparison, and the quality metric comprises PSNR, structural similarity index measure (SSIM), MS-SSIM, or video multi-method assessment fusion (VMAF), and
wherein the down-sampling ratio is present in a video unit level, and CNN information is included in the SPS, the PPS, the picture header, the slice header, the CTU, or the CTB.

14. The method of claim 2, wherein a chroma format of input is changed depending on different down-sampling ratios of color components, and a changed chroma format is used for compression in an encoder,
wherein the chroma format is changed from YUV 4:2:0 to YUV 4:4:4 when a down-sampling ratio is 2 for a luma component and is 1 for chroma components, and YUV 4:4:4 is used as the chroma format for compression,
wherein information to recover an original chroma format is present in a video unit level,
wherein the down-sampling ratios for all the color components are included in the SPS, the PPS, the picture header, the slice header, the CTU, or the CTB, and
wherein the original chroma format is included in the SPS, the PPS, the picture header, the slice header, the CTU, or the CTB.

15. The method of claim 2, wherein a luma component is down-sampled at all video unit levels, and a video unit comprises at least one of: a sequence, a picture, a slice, a tile, a brick, a subpicture, a CTU, a CTU row, one or more coding units (CUs), one or more CTUs, one or more CTBs, and
wherein the luma component that is down-sampled is one frame or one CTU.

16. The method of claim 2, wherein the down-sampling model that is NN based is used in an encoder and a decoder, and a NN based in-loop filter is used,
wherein two NN based in-loop filters are applied to down-sampled luma reconstruction and chroma reconstruction, respectively,
wherein as one input of the NN based in-loop filter for chroma, the down-sampled luma reconstruction is concatenated with chroma reconstruction, and
wherein the NN based super resolution is applied to luma components of reconstructed YUV as a post filter to recover an original chroma format, or the NN based super resolution is applied before in-loop filters to recover the original chroma format.

17. The method of claim 1, wherein the conversion comprises encoding the current video block into the bitstream.

18. The method of claim 1, wherein the conversion comprises decoding the current video block from the bitstream.

19. An apparatus for processing video data comprising a processor and a non-transitory memory with instructions thereon, wherein the instructions upon execution by the processor, cause the processor to:
determine to apply neural network (NN) based super resolution; and
perform a conversion between a current video block of a video and a bitstream of the video based on the determining.

20. A non-transitory computer-readable recording medium storing a bitstream of a video which is generated by a method performed by a video processing apparatus, wherein the method comprises:
determining to apply neural network (NN) based super resolution; and
generating the bitstream of the video based on the determining.
